(19) United States
(12) Patent Application Publication
(10) Pub. No.: US 2023/0404033 A1
(43) Pub. Date: Dec. 21, 2023

(54) PET COMB

(71) Applicant: Qiwen XUE, Qinhuangdao City (CN)

(72) Inventor: Qiwen XUE, Qinhuangdao City (CN)

(21) Appl. No.: 17/941,070

(22) Filed: Sep. 9, 2022

(30) Foreign Application Priority Data
Jun. 10, 2022 (CN) 2022221643114

(51) Int. Cl. A01K 13/00; A46B 9/02; A46B 15/00; A46B 1/00

(52) U.S. Cl. CPC A01K 13/002; A46B 9/02; A46B 2200/1093; A46B 1/00; A46B 15/002

(57) ABSTRACT

The utility model discloses a pet comb, including a shell, where a roller is rotationally connected to an interior of the shell, and is set as a collection groove with a notch formed in a side wall, an opening is formed in the shell corresponding to the roller, and electrostatic hair-sticking cloths are arranged on an outer wall of the roller; the shell is provided with comb bodies, and the comb bodies are arranged on two sides of the shell; and a blocking strip is arranged on an inner wall of the shell, and is in scratching fit with the electrostatic hair-sticking cloths. The utility model has the following advantages and effects: the solution uses a new mechanical structure, and has the effects of simple structure, convenient use, firm connection and capabilities of combing and sticking hairs, repeatedly removing hairs and being used for many times.

### TECHNICAL FIELD

The utility model relates to the technical field of a pet cleaning apparatus, and in particular, to a pet comb.

### BACKGROUND

With the increase of people's life pressure, more and more people prefer to relieve stress by raising a pet. Pet owners usually need to spend time combing pet hairs, and although a comb available on the market can comb the pet hairs finely, fluffy that falls off in the combing process tends to flutter around the house, which seems not hygienic, and causes allergic reactions in people who are allergic to hairs in the house. Therefore, after the pet hairs are combed, it usually takes more time to clean up the fallen pet hairs, which is a waste of time.

### SUMMARY

In order to overcome the defects existing in a conventional comb, according to a pet comb provided by the utility model, a shell is additionally provided with an electrostatic adsorption device, comb bodies and a roller with a collection groove, and the comb bodies are arranged on a side surface of an electrostatic adsorption device, so that the pet comb has the effects of firm connection, and capabilities of combing and sticking hairs.

The technical objective of the utility model is achieved by the following technical solution: a pet comb includes a shell, where a roller is rotationally connected to an interior of the shell, and is set as a collection groove with a notch formed in a side wall, an opening is formed in the shell corresponding to the roller, and electrostatic hair-sticking cloths are arranged on an outer wall of the roller; the shell is provided with comb bodies, and the comb bodies are arranged on two sides of the shell; and a blocking strip is arranged on an inner wall of the shell, and is in scratching fit with the electrostatic hair-sticking cloths.

By adoption of the above technical solution, the comb bodies can comb the pet hairs, and the electrostatic hair-sticking cloths on the surface of the roller rub against the body surface of a pet. When the pet hairs or the dandruff falls off in the combing process, the electrostatic hair-sticking cloths can effectively and electrostatically adsorb the floating hairs and dandruff falling from the body of the pet, so that hair combing and sticking can be performed at the same time, the problem that the hairs flutter in the hair combing process of the pet is solved, the remaining quantity of the floating hairs on the body of the pet after hair combing can be reduced as far as possible, the falling quantity of the pet hairs in the combing process is greatly reduced, and the clearing operation of the pet hairs in rooms in the subsequent process is greatly reduced. The roller rotates, so that the electrostatic hair-sticking cloths on the side wall of the roller are in scratching fit with the blocking strip on the inner wall of the shell, the floating hairs and the dandruff on the electrostatic hair-sticking cloths are scraped into the collection groove, the floating hairs and the dandruff can be collected, and the pet comb can be used for many times, and has the advantages of simple structure, convenient use, recyclability, and capability of combing and sticking hairs.

The utility model is further set as follows: several arc-shaped grooves are formed in an outer wall of the roller, and the electrostatic hair-sticking cloths are arranged in the arc-shaped grooves.

By adoption of the above technical solution, due to the arc-shaped grooves, the pasting of the electrostatic hair-sticking cloths is limited, and it is convenient for a user to stick the electrostatic hair-sticking cloths on the outer wall of the roller.

The utility model is further set as follows: several soft hairs are arranged on one side of each electrostatic hair-sticking cloth.

By adoption of the above technical solution, due to the soft hairs, the pet hairs which are electrostatically adsorbed by the electrostatic hair-sticking cloths are absorbed on the soft hairs instead of being directly adsorbed on the electrostatic hair-sticking cloths, so that a certain gap is formed between the adsorbed pet hairs and the electrostatic hair-sticking cloths, which is conducive to the subsequent separation of the pet hairs from the electrostatic hair-sticking cloths.

The utility model is further set as follows: several blocking hairs are arranged on the blocking strip.

By adoption of the above technical solution, the blocking hairs enable the blocking strip to scrape the floating hairs and the dandruff on the electrostatic hair-sticking cloths, so as to avoid occurrence of insufficient scraping and insufficient collection of the floating hairs and the dandruff, and improve the hair removing efficiency to a certain extent.

The utility model is further set as follows: the shell is provided with a limiting sliding groove, the roller is provided with a toggle bar, the toggle bar is in limit fit with the limiting sliding groove, and when the toggle bar moves relative to the limiting sliding groove, the roller is driven to rotate relative to the shell.

By adoption of the above technical solution, when the pet hairs are adsorbed on the electrostatic hair-sticking cloths, a user can toggle the toggle bar along the limiting sliding groove to realize rotation of the roller, and due to the existence of the limiting sliding groove, the roller can only rotate the roller within a limited range. The utility model is further set as follows: the comb bodies are integrally formed on the shell.

By adoption of the above technical solution, the comb bodies and the shell are integrally formed, and are firmly connected with each other. When the comb bodies accidentally drop, the comb bodies and the shell will not be separated, and the connection manner is simple and practical.

The utility model is further set as follows: each comb body includes several comb teeth, and the comb teeth are arranged in side walls of the comb bodies in a single row.

By adoption of the above technical solution, the comb teeth arranged in the single row can comb the pet hairs, and enable the pet hairs not to be knotted, thereby improving smooth degree during hair combing.

The utility model is further set as follows: each comb body includes several comb teeth, the comb teeth are arranged in at least two rows, and the upper and lower comb teeth are staggered.

By adoption of the above technical solution, through the staggered design of the upper and lower teeth, the pet hairs can be combed more finely, thereby effectively reducing the occurrence of inadequate combing of the pet hairs.

The utility model is further set as follows: the shell includes an upper shell and a lower shell, where the upper shell is provided with an upper cover, the lower shell is provided with a connection part, the connection part is provided with several positioning grooves, the upper shell is provided with clamping protrusions corresponding to the positioning grooves, and the clamping protrusions are in positioning fit with the positioning grooves.

By adoption of the above technical solution, the upper shell and the lower shell are in positioning fit with the limiting sliding groove to form a shell through the clamping protrusion, thereby enhancing the buckling property between the upper shell and the lower shell, and preventing the situation that the upper shell and the lower shell are easily separated. When there are more hairs in the collection groove, the upper cover can be opened and the hairs in the collection groove are poured out for quick cleaning.

In summary, the utility model has the following beneficial effects: a shell is provided with an electrostatic adsorption device and comb bodies, the comb bodies are arranged on a side of the electrostatic adsorption device, and the pet comb has the advantages of simple structure, convenient use, and capabilities of combing and sticking hairs, repeatedly removing hairs and being used for many times.

### BRIEF DESCRIPTION OF THE DRAWINGS

FIG. 1 is a structural diagram according to the utility model, where come teeth are in two rows;

FIG. 2 is an exploded view according to the utility model;

FIG. 3 is an exploded view from another perspective according to the utility model;

FIG. 4 is a structural diagram of an upper shell according to the utility model;

FIG. 5 is a structural diagram according to the utility model, where comb teeth are in a single row.

In the drawings: 1. shell; 11. upper shell; 111. clamping protrusion; 112. upper cover; 12. lower shell; 121. connection part; 1211. positioning groove; 13. opening; 14. limiting sliding groove; 15. blocking strip; 151. blocking hair; 2. roller; 21. arc-shaped groove; 22. electrostatic hair-sticking cloth; 221. soft hair; 23. toggle bar; 24. collection groove; 3. comb body; 31. comb tooth.

### DETAILED DESCRIPTION OF THE EMBODIMENTS

The utility mode is further described with reference to the accompanying drawings.

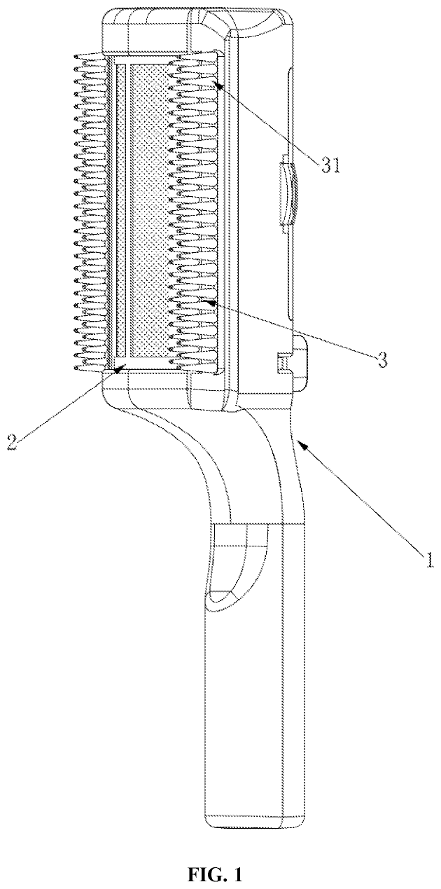

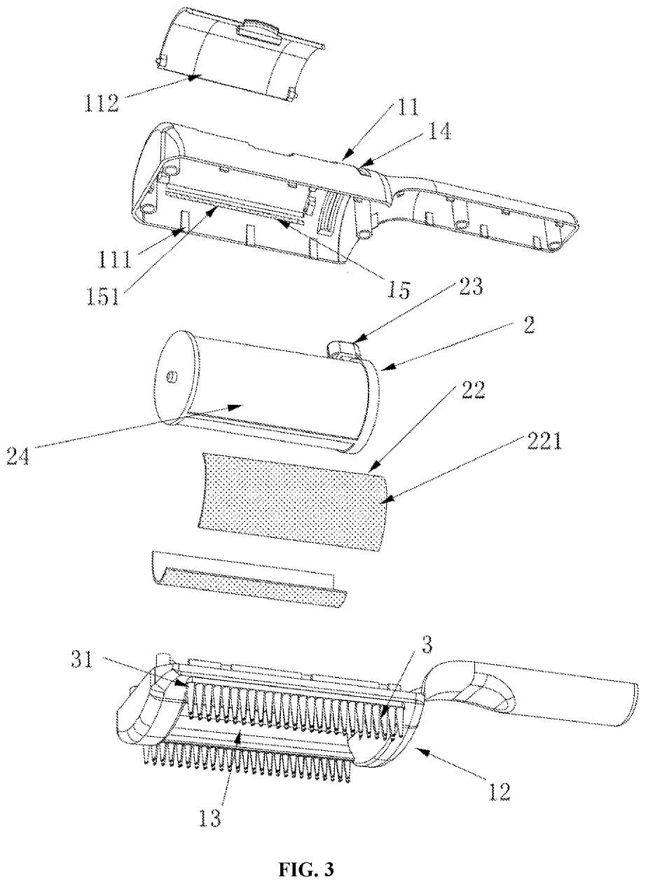

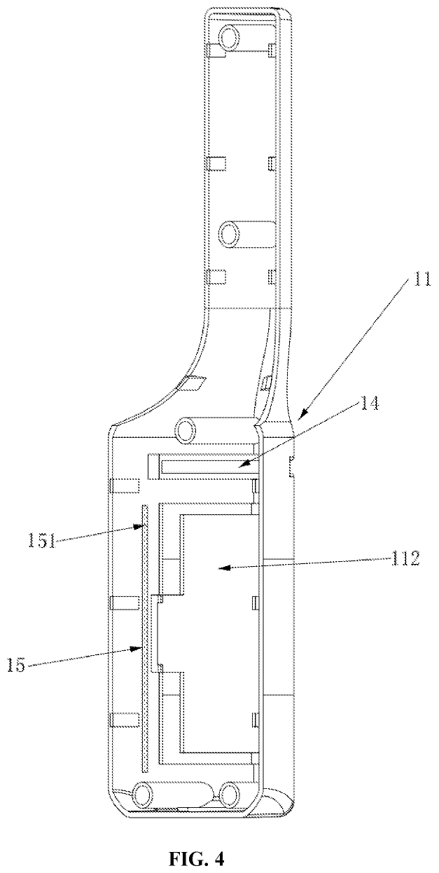

A pet comb, as shown in FIG. 1 to FIG. 4, includes a shell 1, where the shell 1 includes an upper shell 11 and a lower shell 12, the upper shell 11 is provided with an openable upper cover 112, connection parts 121 are arranged on two sides of the lower shell 12 respectively, six positioning grooves 1211 are symmetrically formed in the connection parts 121 on the two sides, six clamping protrusions 111 are arranged at positions, corresponding to the positioning grooves 1211, of the upper shell 11, and the clamping protrusions 111 are in positioning fit with the positioning grooves 1211, so that the buckling degree of the upper shell 11 and the lower shell 12 is increased; two comb bodies 3 are integrally formed on a side wall of the shell 1, each comb body 3 includes several comb teeth 31, and the comb teeth 31 can comb pet hairs; and an electrostatic adsorption device is arranged in the shell 1, and includes a roller 2 rotationally connected to an interior of the lower shell 12, electrostatic hair-sticking cloths 22 are arranged on an outer wall of the roller 2, and an opening 13 is formed at a position of the roller 2 of the lower shell 12, so that the electrostatic hair-sticking cloths 22 on the surface of the roller 2 and the surface hairs of the pet can mutually rub through contact. When the hairs fall off in the process of combing pet hairs by the comb bodies 3, the electrostatic hair-sticking cloths 22 on the roller 2 can effectively adsorb the floating hairs or the dandruff on the body of the pet can be effectively pasted through electrostatical adsorption.

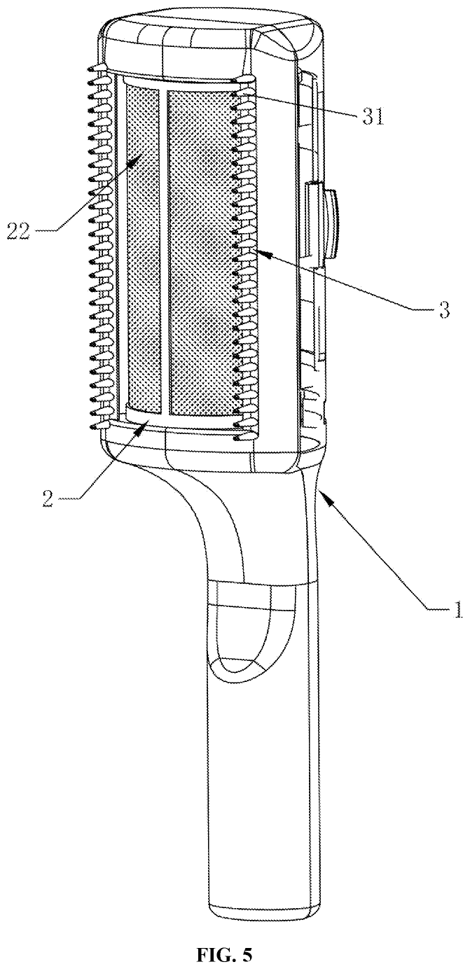

In order to ensure that hairs at each part can be combed, the comb teeth 3131 on two sides of the comb bodies 3 are arranged in two rows, and upper and lower comb teeth 3131 are staggered, as shown in FIG. 1. The staggered comb teeth 3131 can comb the pet hairs more finely. In another embodiment, in order to increase the smooth degree in the process of combing the pet hairs, the pet hairs are not liable to knot in the combing process. As shown in FIG. 5, the comb teeth 31 on two sides of the comb bodies 3 are arranged in a single row.

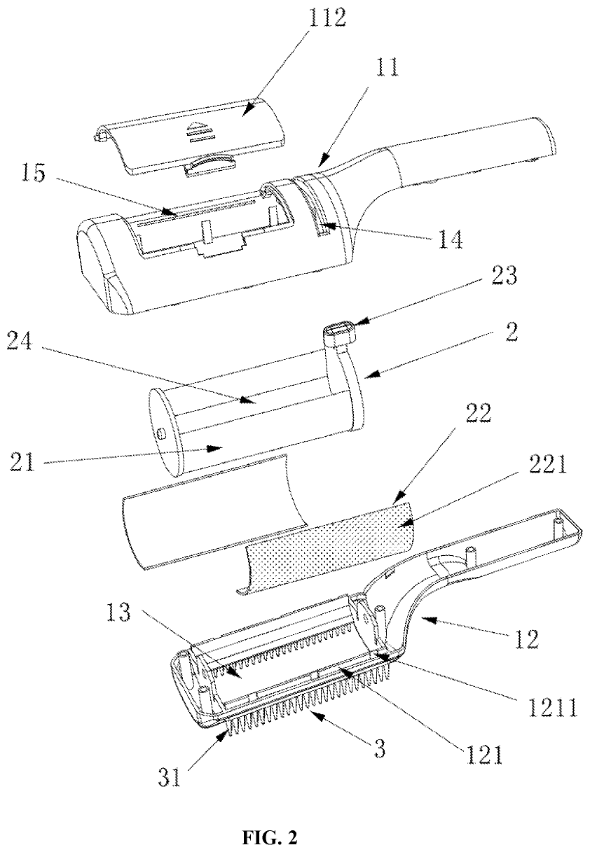

In order to remove the pet hairs on the electrostatic hair-sticking cloths 22, as shown in FIG. 2 to FIG. 4, a collection groove 24 is formed in an upper part of the roller 2, several soft hairs 221 are arranged on one side of each electrostatic hair-sticking cloth 22, a blocking strip 15 is arranged on an inner wall of the shell 1, several blocking hairs 151 are arranged on the blocking strip 15, the roller 2 is provided with a toggle bar 23, the shell 1 is provided with a limiting sliding groove 14, the toggle bar 23 penetrates through the limiting sliding groove 14 to be in limiting fit with the limiting sliding groove, a user can toggle the toggle bar 23 along the limiting sliding groove 14, the collection groove 24 is driven by the toggle bar 23 to rotate relative to the shell 1, the floating hairs and the dandruff on the surfaces of the electrostatic hair-sticking cloths 22 can be recovered into the collection groove 24, and the electrostatic hair-sticking cloths 22 can be subjected to hair removal. When the hairs in the collection groove 24 need to be cleaned, the upper cover 112 can be opened, the hairs in the collection groove 24 can be poured out, and quick cleaning of the collection groove 24 can be realized. In addition, the utility model overall adopts a plastic material and the electrostatic hair-sticking cloths 22, so that the pet comb can be overall washed with water, drying after washing with water for use is facilitated, and the pet comb can be recycled.

In order to facilitate a user to stick the electrostatic hair-sticking cloths 22 on the roller 2 more accurately, as shown in FIG. 1 to FIG. 3, according to the utility model, two arc-shaped grooves 21 are formed in an outer wall of the roller 2, and the electrostatic hair-sticking cloths 22 are detachably arranged in the arc-shaped grooves 21.

The utility model adopts the basic working principle that the comb bodies 3 can comb the pet hairs; when the pet hairs or the dandruff falls off in the combing process, the electrostatic hair-sticking cloths 22 can effectively and electrostatically adsorb the floating hairs and the dandruff falling from the body of the pet, so that hair combing and hair sticking can be performed at the same time, the problem that the hairs flying in the hair combing process of the pet is solved; besides, the remaining quantity of the floating hairs of the pet after hair combing can be reduced as far as possible, the falling quantity of the pet hairs in the combing process is greatly reduced, and the clearing operation of the pet hairs in rooms in the subsequent process is greatly reduced; the roller 2 rotates, and the electrostatic hair-sticking cloths 22 on the side wall of the roller 2 are in scratching fit with the blocking strip 15 on the inner wall of the shell 1, so that the floating hairs and the dandruff on the electrostatic hair-sticking cloths 22 are scraped into the collection groove 24, the floating hairs and the dandruff can be collected, and the pet comb can be used for many times and has the effects of simple structure, convenient use, recyclability, and capabilities of being used for many times, and combing and sticking hairs.

The above description is only a preferred embodiment of the utility model, so any equivalent change or modification made according to the structure, feature and principle described in the patent application scope of the utility model should be included in the patent application scope of the utility model.

What is claimed is:

1. A pet comb, comprising a shell, wherein a roller is rotationally connected to an interior of the shell, and is set as a collection groove with a notch formed in a side wall, an opening is formed in the shell corresponding to the roller, and electrostatic hair-sticking cloths are arranged on an outer wall of the roller; the shell is provided with comb bodies, and the comb bodies are arranged on two sides of the shell; and a blocking strip is arranged on an inner wall of the shell, and is in scratching fit with the electrostatic hair-sticking cloths.

2. The pet comb according to claim 1, wherein several arc-shaped grooves are formed in an outer wall of the roller, and the electrostatic hair-sticking cloths are arranged in the arc-shaped grooves.

3. The pet comb according to claim 1, wherein several soft hairs are arranged on one side of each electrostatic hair-sticking cloth.

4. The pet comb according to claim 1, wherein several blocking hairs are arranged on the blocking strip.

5. The pet comb according to claim 1, wherein the shell is provided with a limiting sliding groove, the roller is provided with a toggle bar, the toggle bar is in limit fit with the limiting sliding groove, and when the toggle bar moves relative to the limiting sliding groove, the roller is driven to rotate relative to the shell.

6. The pet comb according to claim 1, wherein the comb bodies are integrally formed on the shell.

7. The pet comb according to claim 1, wherein each comb body comprises several comb teeth, and the comb teeth are arranged in a side wall of each comb body in a single row.

8. The pet comb according to claim 1, wherein each comb body comprises several comb teeth, the comb teeth are arranged in at least two rows, and the upper and lower comb teeth are staggered.

9. The pet comb according to claim 1, wherein the shell comprises an upper shell and a lower shell, the upper shell is provided with an upper cover, the lower shell is provided with a connection part, the connection part is provided with several positioning grooves, the upper shell is provided with clamping protrusions corresponding to the positioning grooves, and the clamping protrusions are in positioning fit with the positioning grooves.
